(19) United States
(12) Patent Application Publication
(10) Pub. No.: US 2007/0199062 A1
(43) Pub. Date: Aug. 23, 2007

(54) Apparatus and method for performing dynamic security in internet protocol (IP) system

(76) Inventor: Soung-Su Cho, Hwanseong-si (KR)

Correspondence Address: Robert E. Bushnell, Suite 300, 1522 K Street, N.W., Washington, DC, 20005-1202, US

(21) Appl. No.: 11/705,067

(22) Filed: Feb. 12, 2007

(30) Foreign Application Priority Data
Feb. 21, 2006 (KR) 10-2006-0016953

(51) Int. Cl. G06F 15/16

(52) U.S. Cl. 726/12

(57) ABSTRACT

An apparatus and method for performing dynamic security in an Internet Protocol (IP) system. The apparatus includes: a resource pool for storing information on resources related to IP services, and authentication information; and a security module for receiving a request to use resources for the IP services, requesting address translation according to the corresponding resource information stored in the resource pool, or resource reservation for the address translation or operation of a firewall, and requesting interruption of the resource use when the use of the corresponding resources is terminated.

### CLAIM OF PRIORITY

This application makes reference to, incorporates the same herein, and claims all benefits accruing under 35 U.S.C.§119 from an application for APPARATUS AND METHOD FOR SUPPLYING DYNAMIC SECURITY IN IP SYSTEMS earlier filed in the Korean Intellectual Property Office on 21 Feb. 2006 and there duly assigned Ser. No. 10-2006-0016953.

### BACKGROUND OF THE INVENTION

1. Field of the Invention

The present invention relates to an apparatus and method for performing dynamic security in an Internet Protocol (IP) system, and more particularly, to an apparatus and method for performing dynamic security in an IP system that are capable of implementing more dynamic access to a specific resource when Network Address Translation (NAT) or a firewall function is provided in the IP system.

2. Description of the Related Art

Generally, a firewall is a security system capable of selecting, accepting, denying, and correcting information transmitted between an internal network in a company or organization, and the Internet. All types of information are allowed to pass through a system having the same function as the firewall of a building, i.e., a router or an application gateway, installed on a border where the external Internet meets a dedicated communication network in the organization. In other words, the firewall's function is to prevent illegal users from accessing the dedicated communication network, using or disturbing computer resources, or illegally leaking important information to the outside.

The principle of the firewall is to prevent a user other than an authorized computer system or authorized user from accessing a network, and the firewall is the most effective way to prevent illegal access to an information communication network at present. Since various computer systems operate with different operating systems, and security problems of the systems are different, it is difficult to confer a predetermined level of security capability to each host computer.

Conceptually, the firewall is classified into a packet-filtering firewall, a dual-home gateway firewall, a screened host firewall, and so on.

Meanwhile, the Internet has made rapid progress due to the World Wide Web (WWW) and various application programs, and at present, the Internet is used beyond its capability to designate new IP addresses. Such shortage of IP addresses is caused by inefficient allocation according to the IPv4 address system, and the current situation poses a serious threat to the appearance of various applications such as home networking, Internet information electronic appliances, and ubiquitous networking. Although IPv4-to-IPv6 translation, one measure proposed to solve the shortage of the IP addresses, is the best way to solve problems of the current IPv4 system such as IP security, multicasting, and the shortage of IP addresses, it requires considerable time and cost because all IPv4 network equipment and hosts constructed should be changed. While various research and development of IPv4-to-IPv6 translation is ongoing, it is difficult to estimate when the complete IPv6 Internet will be distributed. Therefore, technology currently used to solve the shortage of IP addresses is Network Address Translation (NAT), which basically involves re-writing source and/or destination addresses of IP packets as they pass through a router or firewall. See Network Working Group Request for Comments (RFC)1631 “The IP Network Address Translator (NAT),” and RFC 2663 “IP Network Address Translator (NAT) Terminology and Considerations.”

NAT uses a private IP address in a local network, and supports communication by translating the source address/port of a packet generated in a host when the host of the local network communicates with a global network. Such network translation technology may be divided into Basic NAT translating a source private IP address, and Network Address Port Translation (NAPT) translating a source address and a source port number. See RFC 2663 section 4.1.2.

Since the NAT has a simple translation table to aid in translating the source address, it can be easily implemented, but is less efficient at reusing IP addresses. Because NAPT translates the source address and port, and enables reuse of more IP addresses than NAT, most current network address translation technologies employ NAPT. These network address translation technologies are mainly implemented by a gateway or an edge router in the local network.

As described above, in order to provide specific services in a conventional firewall or NAT apparatus, the firewall should be set to statically grant an IP/port, or the NAT should be set to statically forward a port for the services. In this case, a security problem arises. In other words, when an intruder knows information on the port that is statically set and used for the specific services, an attack using the port can cause a problem with the services.

In addition to the security problem, there is another problem of malfunction of the system due to improper setup by a user. Also, since NAPT arbitrarily uses a port of the system, a user cannot use that port for services.

### SUMMARY OF THE INVENTION

It is an object of the present invention to provide an apparatus and method for performing dynamic security in an IP system, allowing a Network Address Translation (NAT) module or a firewall module of the IP system to access only a specific resource when use of the specific resource is requested and to prevent the access when the use is terminated.

According to an aspect of the present invention, there is provided an apparatus for performing dynamic security in an IP system comprising: a resource pool for storing information on resources related to IP services, and authentication information; and a security module for receiving a request to use resources for the IP services, requesting address translation according to the corresponding resource information stored in the resource pool, or resource reservation for the address translation or operation of a firewall, and requesting interruption of the resource use when the use of the corresponding resources is terminated.

The information on the corresponding resource may comprise information on at least one of a source IP address and port number, a destination IP address and port number, a protocol, and a service type which are related to the IP services, and the authentication information may comprise information on an authentication method and an authentication key for the resources.

The security module may perform a process of authenticating the requested resources using an authentication method and an authentication key in response to a request to generate the resource pool from an external call server, and stores information on the authenticated resources in the resource pool.

The apparatus may further comprise a Network Address Translation(NAT) database (DB) for matching a public IP address and port with a private IP address and port, and storing the matched result.

The NAT module may receive a request of the security module, and perform address translation on the requested resources according to the matched information stored in the NAT DB.

The apparatus may further comprise a firewall DB for storing information on whether or not to allow transmission of a packet accessing each resource.

The firewall module may receive a request of the security module, and perform packet forwarding on the resources requested according to the information in which the firewall DB stores.

According to another aspect of the present invention, there is provided an apparatus for performing dynamic security in an IP system comprising: a Network Address Translation (NAT) database (DB) for matching a public IP address and port with a private IP address and port, and storing the matched result; a firewall DB for storing information on whether or not to allow transmission of a packet accessing each resource; a resource pool for storing information on resources related to IP services, and authentication information; a security module for receiving a request to use resources for the IP services, requesting resource reservation for address translation or operation of a firewall according to the corresponding resource information stored in the resource pool, and requesting interruption of the resource use when the use of the corresponding resources is terminated; a NAT module for receiving a request from the security module, and performing address translation on the requested resources according to the matched information stored in the NAT DB; and a firewall module for receiving a request from the security module, and performing packet forwarding on the requested resources according to information stored in the firewall DB.

According to still another aspect of the present invention, there is provided a method for performing dynamic security in an IP system, the method comprising the steps of: generating a resource pool storing information on resources related to IP services, and authentication information; requesting resource use for operation of Network Address Translation (NAT) or a firewall according to resource information stored in the resource pool with respect to an externally received request for the IP services; and requesting interruption of the resources when the IP services are terminated.

The method may further comprise the step of: receiving a request for use of the resources, and performing address translation on the requested resources according to the address translation matching information.

The method may further comprise the step of: receiving a request for use of the resources, and performing packet forwarding on the requested resources according to firewall information.

According to yet another aspect of the present invention, there is provided a method for performing dynamic security in an IP system, the method comprising the steps of: generating a resource pool storing information on resources related to IP services, and authentication information; requesting to use resources for operation of Network Address Translation (NAT) or a firewall according to resource information stored in the resource pool in response to an externally received request for the IP services; receiving the request for resource use, and performing address translation on the requested resource according to the address translation matching information; receiving the request for resource use, and performing packet forwarding on the requested resource according to the firewall information; and requesting interruption of the resource when the IP services are terminated.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an Internet Protocol (IP) system according to an exemplary embodiment of the present invention;

FIG. 2 is a flowchart illustrating a process of generating a resource database (DB) of an IP system according to an exemplary embodiment of the present invention;

FIG. 3 is a flowchart illustrating a process of requesting call setup according to an exemplary embodiment of the present invention; and

FIG. 4 is a flowchart illustrating a process of intercepting services with respect to a specific resource according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. While the present invention has been described with reference to exemplary embodiments thereof, it will be understood by those skilled in the art that various changes in from and detail may be made therein without departing from the scope of the present invention as defined by the following.

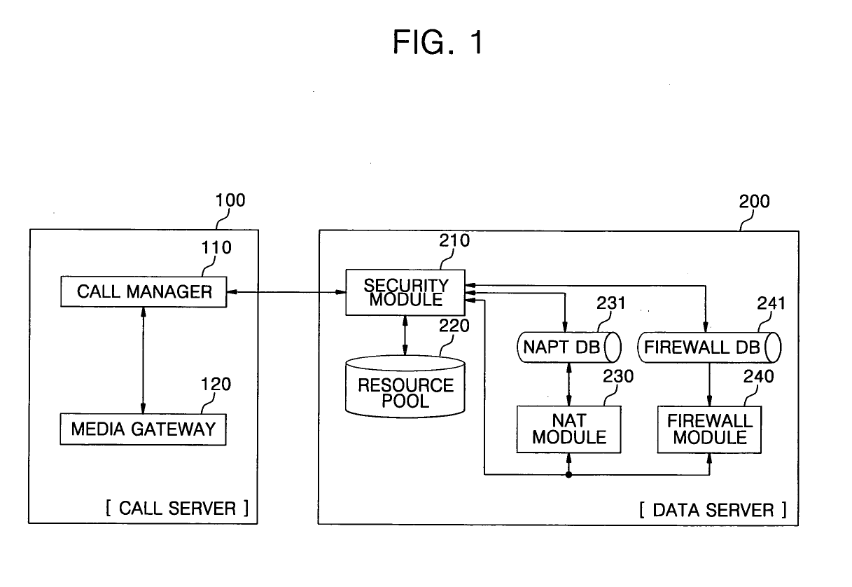

FIG. 1 is a block diagram of an Internet Protocol (IP) system according to an exemplary embodiment of the present invention.

The IP system has a call server 100 and a data server 200 which interwork with each other.

The call server 100 comprises a call manager 110, and a media gateway 120.

The call manager 110 sets up a call for services such as VoIP (Voice over Internet Protocol), and the media gateway 120 serves to covert data between different media.

Here, to be more specific about the media gateway, it is data conversion equipment for transmission of data between different networks complying with different standards, and includes an access gateway and a trunking gateway. The access gateway is equipment for connecting a general telephone user of a wired/wireless network such as a public switched telephone network (PSTN) to a packet network (Voice over Internet Prototol (VoIP) or Voice over Asynchronous Transfer Mode (VoATM)), and converting voice data from the general telephone user so that the voice data can be transmitted to the packet network (VoIP or VOATM). The trunking gateway is for interworking the PSTN with the packet network (VoIP or VOATM), and serves to allow the packet network to transmit a large quantity of data generated in the PSTN.

The data server 200 comprises a security module 210, a resource pool 220, a Network Address Translation (NAT) module 230, a Network Address Port Translation (NAPT) database (DB) 231, a firewall module 240, and a firewall DB 241.

The NAPT DB 231 matches a public IP address and port with a private IP address and port, and stores the matched results. The NAT module 230 translates the address of a received packet with reference to the NAPT DB 231.

The firewall DB 241 stores information on whether or not to allow transmission of a packet accessing each resource in a local network, and the firewall DB 241 has various types as shown in

TABLE 1

| S-Network | S-Ports | D-Network | D-Ports | Protocol |
|---|---|---|---|---|
| 165.213.89.1/24 | 6000:6000 | 165.213.90.2/32 | 6000:6000 | UDP |
| 165.213.86.25/32 | 8000:8100 | 165.213.90.100/32 | 8000:8100 | TCP |

The firewall module 240 allows access to a specific resource, e.g., a source IP address, a source port number, a destination IP address, a destination port number, and a protocol (for example, Transmission Control Protocol (TCP) or User Datagram Protocol (UDP)), according to information stored in the firewall DB 241.

The data server 200 according to the present invention comprises the security module 210 for allowing the NAT module 230, and the firewall module 240 to perform dynamic security on the resources. The data server 200 also comprises a resource pool 220 for storing information on each resource.

Operations of the call and data servers 100 and 200 will be described in connection with the blocks as described above.

First, the operation of the the call server 100 and the data server 200 where a firewall operates will be described below.

The call server 100 performs call processing in order to set up a call for VoIP services,and has information on resources (e.g. IP, a port, a protocol) used when the call processing is performed. The following Table 2 shows an example of the resource information used for the call processing.

TABLE 2

| Resources | Information | Others |
|---|---|---|
| IP | 165.213.89.200 | |
| Port | 6100/TCP | QSIG |
| Port | 6000/UDP | ITP |
| Port | 5060/UDP | SIP |
| . . . | . . . | . . . |

where ITP refers to an IP telephone; QSIG refers to Q signaling; and SIP refers to Session Initiation Protocol.

The call server 100 also has information on media used for the VoIP services, and the following Table 3 shows an example of the media information used for the VoIP services.

TABLE 3

| Resources | Information | Others |
|---|---|---|
| Media IP | 165.213.89.201 | MGI IP |
| Port | 30000/TCP | |
| Port | 30000/UDP | |
| Port | 30002/UDP | |
| . . . | . . . | . . . |

where MGI refers to Media Gateway Interface.

The call server 100 inputs information on the resource in which the server uses for a voice service to the firewall DB 241 of the data server 200, and generates the resource pool 220 so that the firewall can use the service with respect to the corresponding resource upon request of the security module 210. With respect to a request to generate the resource pool 220 from the call server 100, the security module 210 performs an authentication process for the corresponding resource, and then generates the pool when the resource is authenticated. At this time, the authentication is performed using an authentication method and an authentication key. The authentication method uses Point-to-Point Protocol (PPP), Challenge Handshake Authentication Protocol (CHAP), ANY, and the authentication key mostly uses a user account, and a password.

A preferred configuration of the resource pool 220 is shown in Table 4 below.

TABLE 4

| S- | S- | D- | D- | | | Authentication | Authentication |
|---|---|---|---|---|---|---|---|
| Network | Ports | Network | Ports | Protocol | Service | method | key |
| . . . | . . . | . . . | . . . | . . . | NAPT | PPP | admin:passwd |
| . . . | . . . | . . . | . . . | . . . | Firewall | CHAP | passwd |
| . . . | . . . | . . . | . . . | . . . | NAPT | ANY | |

As described in Table 4, the information stored in the resource pool 220 includes a service type regarding whether the NAPT or the firewall is used, the authentication method, a value of the authentication key, etc., in addition to the IP address and port of the source network, the IP address and port of the destination network, and the protocol. Here, the information on the IP address and port of the source network, the IP address and port of the destination network, and the protocol has the same type as that of the firewall DB 241 as described in Table 1. When the authentication method is PPP, the user account and the password are used for the authentication key. When the authentication method is CHAP, the password is used for the authentication key. Also, when the authentication method is ANY, the authentication key is not used.

When call setup is requested by a terminal, the call server 100 makes a request to use specific ones of the resources, which are stored in the resource pool 220 by the security module 210 of the data server 200, such as IP address and port number, and a protocol for the call setup, information for the media, etc. When the use of the corresponding resources is requested, the security module 210 requests the firewall module 240 to allow the use of the corresponding resources. When the corresponding services are terminated, the call server 100 reports termination of the services using the resources to the security module 210. The security module 210 intercepts the use of the corresponding resources, which are set for the firewall.

Next, the case where the call server 100 has a private IP according to NAT will be described.

The call server 100 should be provided with NAPT services from an upper router in order to perform a voice service with a different call server 100 or a terminal, which is located on an external network. In other words, NAPT for the information related to call processing (for example, SIP 5060 UDP, H.323 1719, 1720 . . . ), and NAPT for the media are required. When the call server 100 uses the private IP under a NAT system, it requests NAPT information for the voice service to the security module 210 of the data server 200, and the security module 210 sets corresponding information for the NAT DB, and makes reservation for a resource. When a request for the call setup is received from a terminal, the call server 100 requests the security module 210 to perform NAPT on the resource required for the call setup and the services.

With respect to the request for NAPT, the security module 210 sets NAPT for the NAT module 230 in connection with the corresponding resource in the DB reserved for NAT. The call server 100 receiving acknowledgement (ACK) of the request for NAPT performs call setup processing, and performs the voice service. Then, when the call is terminated, the call server 100 notifies cancellation of NAPT, which is set for the security module 210. The security module 210 receiving the cancellation notification of NAPT records a state of the resource pool 220, and requests the NAT module 230 to stop the services for the corresponding information.

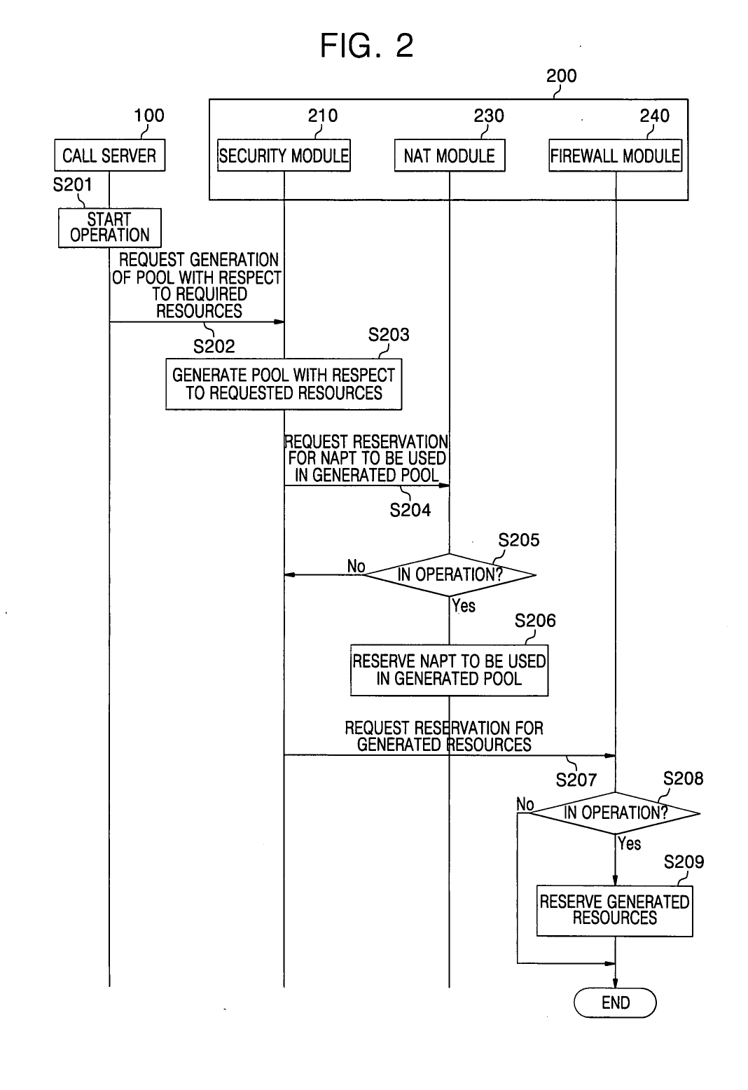

FIG. 2 is a flowchart illustrating a process of generating a resource DB of an IP system according to an exemplary embodiment of the present invention.

The call server 100 according to the present invention requests reservation to the corresponding module of the data server 200 so as to generate a pool for resources required for services. This process is illustrated in FIG. 2.

Initially, the call server 100 operates (S201), and when it is necessary to provide services, such as VoIP, the call server requests the security module 210 of the data server 200 to generate a pool for the resources (S202). The security module 210 performs a process of authenticating the requested resources, and generates the resource pool 220 of the authenticated resources (S203). The security module 210 requests the NAT module 230 to reserve NAPT to be used in the generated pool (S204). It is then checked to determine the operation state of the NAT module 230, and when it is determined that the NAT module 230 operates (Yes of S205), the NAT module 230 reserves NAPT to be used in the generated pool, and updates the NAT DB (S206).

When it is determined in step S205 that the NAPT module 230 does not operate, the security module 210 transmits a request for reservation of the generated resources to the firewall module 240 (S207). It is then checked to determine the operation state of the firewall module 240, and when it is in an activated state (Yes of S208), the firewall module 240 reserves the corresponding resource (S209), and updates the firewall DB 241. If not in an activated state the process ends.

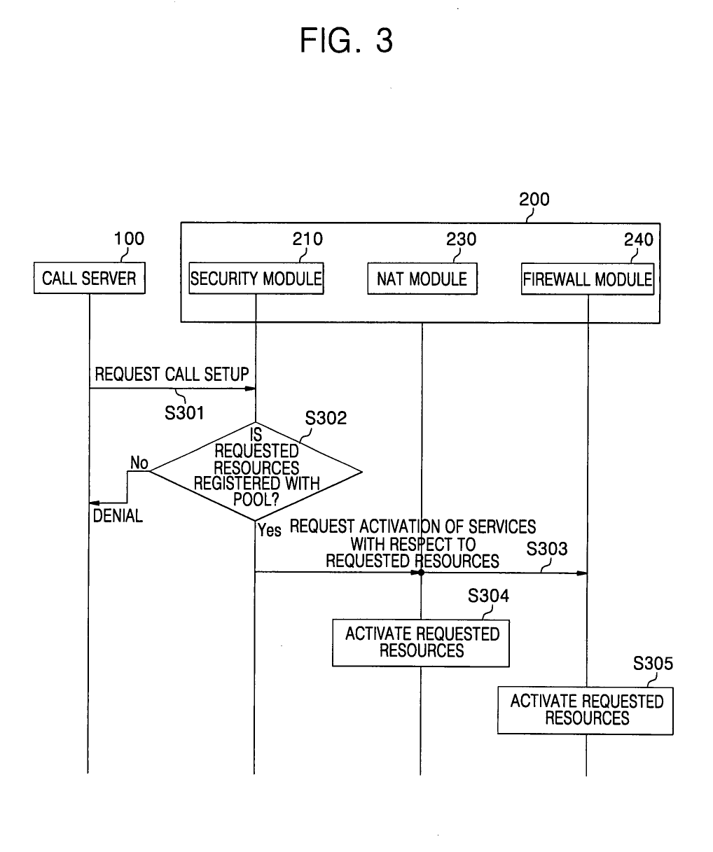

FIG. 3 is a flowchart illustrating a process of requesting call setup according to an exemplary embodiment of the present invention.

When a request for call setup is received from a terminal, the call server 100, according to the present invention, transmits the call setup request indicating use of corresponding resources to the security module 210, and the security module 210 requests the firewall module 240 or the NAT module 230 to provide services in response to the requested information.

More specifically, the call server 100 transmits a request for call setup to the security module 210 of the data server 200 (S301). After receiving the call setup request, the security module 210 checks whether the requested resources are registered with the resource pool 220 (S302). When the requested resources are registered with the resource pool 220 (Yes of S302), the security module 210 requests the NAT module 230 and the firewall module 240 to activate services with respect to the requested resources (S303).

Here, when the NAT module 230 or the firewall module 240 does not operate, the security module 210 does not transmit the request for service activation of the requested resources. The NAT module 230 and the firewall module 240 that receive a request for service activation of specific resources activate the corresponding resources by allowing use of the requested resources (S304 and S305).

When the requested resources are not registered with the resource pool 220 (No of S302), the security module 210 sends a denial of services message to call server 100.

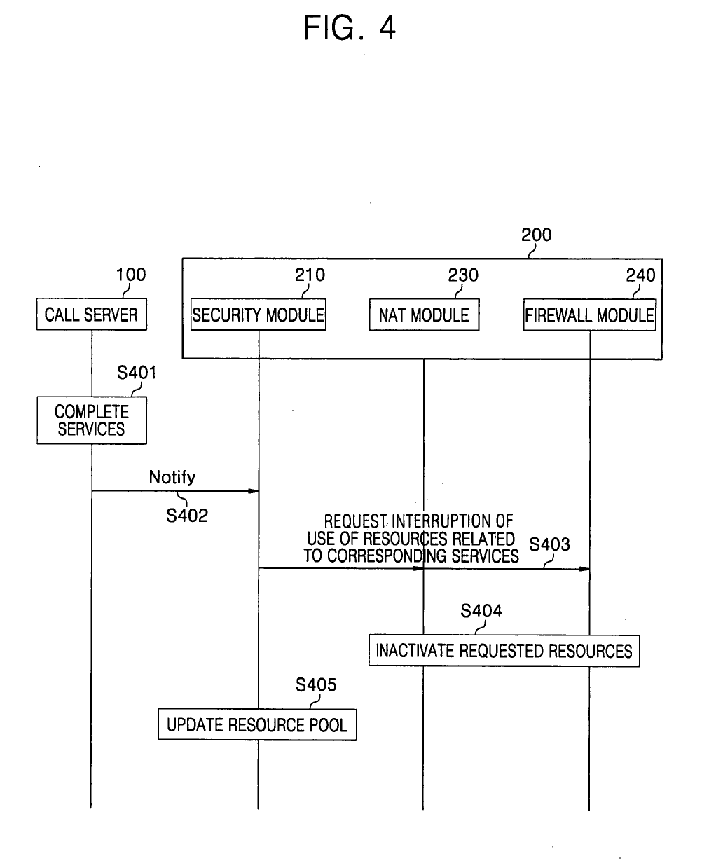

FIG. 4 is a flowchart illustrating a process of intercepting services with respect to specific resources according to an exemplary embodiment of the present invention.

When a call service is completed or terminated (S401), the call server 100 transmits a notification message to the security module 210 notifying it of the termination of services (S402), and the security module 210 receiving the notification message requests the firewall module 240 or the NAT module 230 to prevent or interrupt use of the services with respect to the corresponding resources (S403). The NAT module 230 and the firewall module 240 that receive the request for interruption of the services inactivate the corresponding resources (S404).

Meanwhile, the security module 210 updates the resource pool 220 in an available state notifying that the corresponding resources can provide other services, because the security module 210 prevents the provision of the services with respect to the corresponding resources (S405).

As described above, the present invention is characterized in that the data server in which the firewall operates dynamically allows the media, of which the corresponding terminals and other terminals make use when the terminals (ITP/DG (DG=Digital Phone)) located inside/outside the firewall makes a call, through the firewall with the outside with respect to the call server located inside/outside the firewall.

Also, in the case of the data server in which NAT operates, the call server informs the data server of the call processing and the media when the call server sets up NAPT for the call processing between the call server and terminals inside/outside NAT, and NAPT for the media, and the data server dynamically sets up NAPT for the services, and receives the notification of the call server when the call is terminated, and cancels the set NAPT.

Moreover, in the case where the firewall and the NAT simultaneously operate, the data server and the call server performs all operations for the firewall and the NAT as described above.

When providing a security function of IP services, the present invention can strengthen the security for the IP system by allowing access to the specific resources only when the IP services requested by the firewall or NAT are provided, and by preventing access to the corresponding resources when the corresponding services are terminated.

While the present invention has been described with reference to exemplary embodiments thereof, it will be understood by those skilled in the art that various changes in from and detail may be made therein without departing from the scope of the present invention as defined by the following claims.

What is claimed is:

1. An apparatus for performing dynamic security in an Internet Protocol (IP) system comprising at least one of a Network Address Translation (NAT) module and a firewall module, the apparatus comprising:
a resource pool for storing information on resources related to IP services, and authentication information; and
a security module for receiving a request to use resources for the IP services, requesting address translation according to the corresponding resource information stored in the resource pool, or resource reservation for the address translation or operation of a firewall, and requesting interruption of the resource use when the use of the corresponding resources is terminated.

2. The apparatus according to claim 1, wherein the resource information comprises information on at least one of a source IP address and port number, a destination IP address and port number, a protocol, and a service type which are related to the IP services.

3. The apparatus according to claim 1, wherein the authentication information comprises information on an authentication method and an authentication key for the resources.

4. The apparatus according to claim 1, wherein the security module performs a process of authenticating the requested resources using an authentication method and an authentication key in response to a request to generate the resource pool from an external call server, and stores information on the authenticated resources in the resource pool.

5. The apparatus according to claim 1, further comprising a Network Address Translation (NAT) database (DB) for matching a public IP address and port with a private IP address and port, and storing the matched result.

6. The apparatus according to claim 5, wherein the Network Address Translation (NAT) module receives a request from the security module, and performs address translation on the requested resources according to the matched information stored by the Network Address Translation (NAT) database (DB).

7. The apparatus according to claim 1, further comprising a firewall database for storing information on whether or not to allow transmission of a packet accessing each resource.

8. The apparatus according to claim 7, wherein the firewall module receives a request from the security module, and performs packet forwarding on the requested resources according to information stored by the firewall database.

9. An apparatus for performing dynamic security in an Internet Protocol (IP) system, comprising:
a Network Address Translation (NAT) database (DB) for matching a public IP address and port with a private IP address and port, and storing the matched result;
a firewall database for storing information on whether or not to allow transmission of a packet accessing each resource;
a resource pool for storing information on resources related to IP services, and authentication information;
a security module for receiving a request to use resources for the IP services, requesting resource reservation for address translation or operation of a firewall according to the corresponding resource information stored in the resource pool, and requesting interruption of the resource use when the use of the corresponding resources is terminated;
a Network Address Translation (NAT) module for receiving a request from the security module, and performing address translation on the requested resources according to the matched information stored in the Network Address Translation (NAT) database (DB); and
a firewall module for receiving a request from the security module, and performing packet forwarding on the requested resources according to information stored in the firewall database.

10. The apparatus according to claim 9, wherein the resource information comprises at least one of information on a source IP address and port number, a destination IP address and port number, a protocol, and a service type, all of which are related to the IP services.

11. The apparatus according to claim 9, wherein the authentication information comprises information on an authentication method and an authentication key with respect to each resource.

12. The apparatus according to claim 9, wherein the security module performs a process of authenticating the requested resources using the authentication method and the authentication key in response to a request from an external call server to generate the resource pool, and stores the authenticated resources in the resource pool.

13. A method for performing dynamic security in an Internet Protocol (IP) system, the method comprising steps of:
generating a resource pool storing information on resources related to IP services, and authentication information;
requesting resource use for operation of Network Address Translation (NAT) or a firewall according to resource information stored in the resource pool with respect to an externally received request for the IP services; and
requesting interruption of the resources when the IP services are terminated.

14. The method according to claim 13, wherein the resource information comprises one of information on a source IP address and port number, a destination IP address and port number, a protocol, and a service type, all of which are related to the IP services.

15. The method according to claim 13, wherein the authentication information comprises information on an authentication method and an authentication key with respect to each resource.

16. The method according to claim 13, wherein the step of generating the resource pool comprises the steps of:
performing a process of authenticating the requested resources using the authentication method and the authentication key in response to a request to generate the resource pool received from an external call server; and
storing only the authenticated resources in the resource pool after the authentication process.

17. The method according to claim 13, further comprising the step of receiving a request for use of the resources, and performing address translation on the requested resources according to the address translation matching information.

18. The method according to claim 14, farther comprising the step of receiving a request for use of the resources, and performing packet forwarding on the requested resources according to firewall information.

19. A method for performing dynamic security in an Internet Protocol (IP) system, the method comprising steps of:
generating a resource pool storing information on resources related to IP services, and authentication information;
requesting to use resources for operation of Network Address Translation (NAT) or a firewall according to resource information stored in the resource pool in response to an externally received request for the IP services;
receiving the request for resource use, and performing address translation on the requested resource according to the address translation matching information;
receiving the request for resource use, and performing packet forwarding on the requested resource according to the firewall information; and
requesting interruption of the resource when the IP services are terminated.
